(19) United States
(12) Patent Application Publication
(10) Pub. No.: US 2004/0264790 A1
(43) Pub. Date: Dec. 30, 2004

(54) Method of and apparatus for adaptively encoding motion image according to characteristics of input image

(75) Inventors: Byung-cheol Song, Suwon-si (KR); Kang-wook Chun, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/793,662

(22) Filed: Mar. 5, 2004

(30) Foreign Application Priority Data
Mar. 6, 2003 (KR) 2003-14004

(51) Int. Cl. G06K 9/36

(52) U.S. Cl. 382/239

(57) ABSTRACT

A method of and apparatus for adaptively encoding a motion image by using characteristics of the motion image are provided. The method involves (a) calculating temporal complexity of a predetermined section of input image data; (b) determining a frame rate for the predetermined section based on a result of comparing the calculated temporal complexity with a predetermined threshold value; and (c) virtually adjusting a frame rate of the predetermined section based on the determined frame rate.

### BACKGROUND OF THE INVENTION

This application is based on and claims priority from Korean Patent Application No. 2003-14004, filed on Mar. 6, 2003, in the Korean Intellectual Property Office, the disclosure of which is incorporated herein in its entirety by reference.

1. Field of the Invention

The present invention relates to an apparatus and method for encoding a motion image, and more particularly, to a method and apparatus for adaptively encoding a motion image according to characteristics of an input image.

2. Description of the Related Art

Recently, research on image compression technology has been vigorously carried out in accordance with the popularization of digital video recorders (DVRs) or personal video recorders (PVRs). A conventional DVR or PVR merely compresses a motion image according to a resolution level, without considering the characteristics of the input image. Thus, the conventional DVR or PVR has a problem of low data compression efficiency.

FIG. 1 is a block diagram of a conventional motion image encoding system. Input image data is divided into 8×8 pixel blocks. A discrete cosine transform (DCT) unit 110 carries out DCT on image data, which is input into the conventional motion image encoder on an 8×8 pixel-by-8×8 pixel basis, to remove spatial correlation in the image data. A quantization unit 120 represents DCT coefficients provided by the DCT unit 110 with several representative values by carrying out quantization, thereby achieving highly efficient lossly compression. A variable length coding (VLC) unit 130 entropy-encodes the DCT coefficients quantized by the quantization unit 120 and then outputs an entropy-encoded data stream.

An inverse quantization unit 140 inversely quantizes image data quantized by the quantization unit 120. An inverse DCT unit 150 carries out inverse DCT on image data inversely quantized by the inverse quantization unit 140. A frame memory unit 160 stores image data subjected to inverse DCT by the inverse DCT unit 150 on a frame-by-frame basis. A motion estimation unit 170 is provided for removing temporal correlation using image data of a current frame and image data of a previous frame stored in the frame memory unit 160.

The conventional motion image encoding apparatus of FIG. 1 is disclosed in U.S. Pat. No. 6,122,321.

A conventional DVR or PVR uses an MPEG-2 encoding apparatus, like the one shown in FIG. 1. If input image data is yet to be compressed, the input image data is compressed using the MPEG-2 encoding apparatus, and then the compressed image data is stored in a storage medium, such as a hard disk drive (HDD) or a digital versatile disk (DVD). On the other hand, if input image data is a compressed bitstream, the input image data is MPEG-2-decoded first using a apparatus for transcoding a motion image shown in FIG. 2. Thereafter, a desired MPEG-2 data stream is created by the apparatus for transcoding a motion image that scales downs, format-converts, and MPEG-2-encodes the input image data.

FIG. 2 is a block diagram of a conventional apparatus for transcoding a motion image. If the input image data is a compressed bitstream, a motion image decoding unit 220 decodes the input image data. The motion image decoding unit 220 includes a VLC decoding unit 222, an inverse quantization unit 224, an inverse DCT unit 226, a frame memory unit 228, and a motion estimation unit 230. Thereafter, in order to produce a desired MPEG-2 data stream, the decoded image data is encoded according to a set resolution by using an MPEG-2 encoding unit 260, like the motion image encoding system of FIG. 1. This type of encoding is called transcoding. In transcoding the decoded image data, the decoded image data is scaled down or format-converted using a scale and format conversion unit 240 and then MPEG-2-encoded according to the set resolution using the MPEG-2 encoding unit 260.

As described above, in the prior art, MPEG-2 encoding is carried out according to a resolution level. Therefore, irrespective of the characteristics of an input motion image, i.e., irrespective of whether the input motion image has high temporal complexity or whether or not the input motion image has temporal variations, a high frame rate of 30 Hz should be maintained, which results in low encoding efficiency.

### SUMMARY OF THE INVENTION

The present invention provides a method of and apparatus for adaptively encoding a motion image, which enhance encoding and decoding efficiency by considering the characteristics of an input motion image.

According to an aspect of the present invention, there is provided a method of adaptively encoding a motion image. The method involves (a) calculating temporal complexity of a predetermined section of input image data; (b) determining a frame rate for the predetermined section based on a result of comparing the calculated temporal complexity with a predetermined threshold value; and (c) virtually adjusting a frame rate of the predetermined section based on the determined frame rate.

According to another aspect of the present invention, there is provided an apparatus for adaptively encoding a motion image. The apparatus includes a temporal complexity calculation unit which calculates temporal complexity of a predetermined section of input image data; a frame rate determination unit which determines a frame rate for the predetermined section based on a result of comparing the calculated temporal complexity with a predetermined threshold value; and a frame rate adjustment unit which virtually adjusts a frame rate of the predetermined section based on the determined frame rate.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional motion image encoding system;

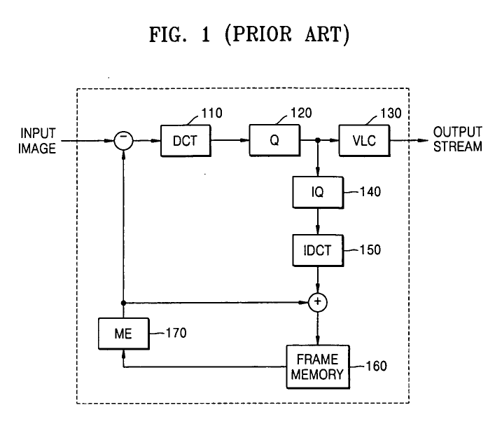

FIG. 2 is a block diagram of a conventional transcoding apparatus;

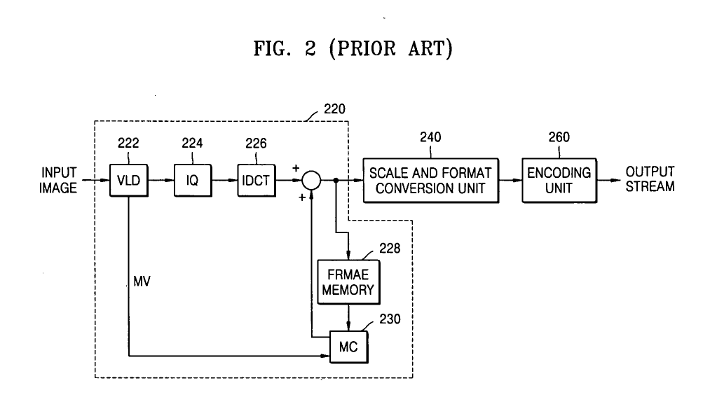

FIG. 3 is a block diagram of an apparatus for adaptively encoding a motion image by using temporal complexity, according to an exemplary embodiment of the present invention;

FIG. 4 is a block diagram of a temporal complexity calculation unit according to a examplary embodiment of the present invention;

FIG. 5 is a diagram illustrating the operation of a frame rate determination unit according to an exemplary embodiment of the present invention;

FIGS. 6A through 6C are diagrams illustrating a virtual frame rate adjustment method according to an exemplary embodiment of the present invention;

FIG. 7 is a table illustrating a virtual frame rate adjustment method according to an exemplary embodiment of the present invention;

FIG. 8 is a flowchart of a method of adaptively encoding a motion image by using temporal complexity, according to an exemplary embodiment of the present invention;

FIG. 9 is a block diagram of an apparatus for adaptively transcoding a motion image by using temporal complexity, according to an exemplary embodiment of the present invention; and

FIG. 10 is a flowchart of a method of adaptively transcoding a motion image by using temporal complexity, according to an exemplary embodiment of the present invention.

### DETAILED DESCRIPTION OF THE INVENTION

Hereinafter, the present invention will be described more fully with reference to the accompanying drawings in which exemplary embodiments of the invention are shown.

Recently, research on image compression technology has been vigorously carried out in the DVR or PVR-related field. One of the most important goals of image compression technology is to achieve a highest possible compression efficiency. However, the conventional DVR or PVR can only compress images according to a certain level of resolution.

The present invention solves problems of the prior art by encoding input motion images on a group of pictures (GOP)—by—GOP basis using different temporal resolutions according to the temporal complexity of the motion images. Thus, it is possible to compress motion images with high efficiency.

In addition, it is possible to enhance encoding and decoding efficiency by reducing the frame rate of a GOP having low temporal complexity, i.e., a GOP having small motion.

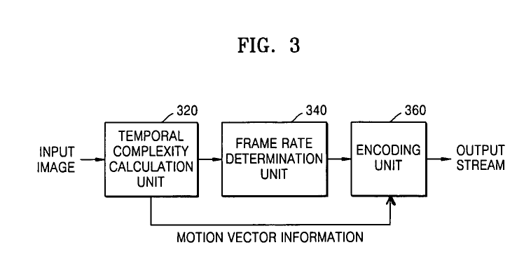

FIG. 3 is a block diagram of an apparatus for adaptively encoding a motion image by using temporal complexity, according to an exemplary embodiment of the present invention. Referring to FIG. 3, the apparatus includes a temporal complexity calculation unit 320, a frame rate determination unit 340, and an encoding unit 360.

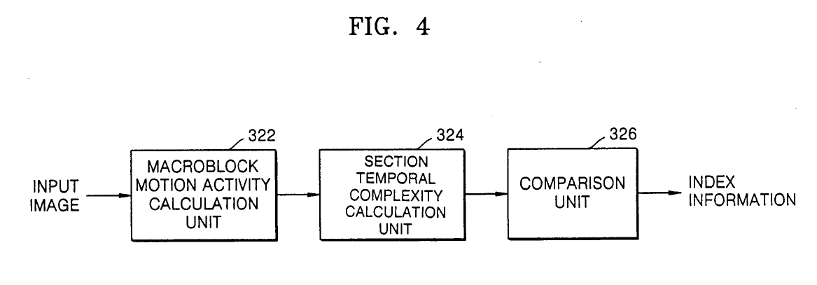

The temporal complexity calculation unit 320 calculates motion vector information of input image data, calculates temporal complexity of each section of the input image data, i.e., temporal complexity of each GOP of the input image data, and transmits the temporal complexity to the frame rate determination unit 340. The motion vector information calculated by the temporal complexity calculation unit 320 is also transmitted to the encoding unit 360 to be used for encoding the input image data. The operation of the temporal complexity calculation unit 320 will be described more fully with reference to FIG. 4 in the following paragraphs.

FIG. 4 is a block diagram of the temporal complexity calculation unit 320 of FIG. 3. The temporal complexity calculation unit 320 includes a macroblock motion activity calculation unit 322, a section temporal complexity calculation unit 324, and a comparison unit 326.

The macroblock motion activity calculation unit 322 obtains a motion vector for each macroblock in a predetermined section, for example, in a GOP, and calculates motion activity of each macroblock using the motion vector for each macroblock.

The section temporal complexity calculation unit 324 calculates temporal complexity of the predetermined section using the motion activity of each macroblock calculated by the macroblock motion activity calculation unit 322. According to an embodiment of the present invention, in the case where a motion vector MV of a macroblock is represented by (MV1, MV2), a motion activity of the motion vector MV is defined by MV1²+MV2². In addition, in the embodiment of the present invention, a maximum among motion activities of macroblocks in the predetermined section is determined as the temporal complexity of the predetermined section. Alternatively, an average of the motion activities of the macroblocks in the predetermined section can be determined as the temporal complexity of the predetermined section.

The comparison unit 326 compares the temporal complexity of the predetermined section, calculated by the section temporal complexity calculation unit 324, with a predetermined threshold value and transmits a result of the comparison to the frame rate determination unit 340. A frame rate can be controlled by appropriately adjusting the predetermined threshold value. The predetermined threshold value is preferably determined experimentally. Alternatively, the frame rate can be adjusted based on the result of comparing several threshold values with the temporal complexity of the predetermined section. According to an embodiment of the present invention, the result of comparing the temporal complexity of the predetermined section with the predetermined threshold value is obtained as index information. For example, if the temporal complexity of the predetermined section is lower than a first threshold value TH1, the index information has a value of 0. If the temporal complexity of the predetermined section is higher than the first threshold value TH1 but lower than a second threshold value TH2, the index information has a value of 1. If the temporal complexity of the predetermined section is higher than the second threshold value TH2, the index information has a value of 2.

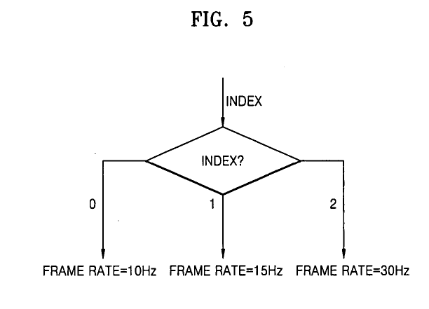

FIG. 5 is a diagram illustrating the operation of the frame rate determination unit 340 of FIG. 3. If the index information input from the frame rate determination unit 340 of FIG. 3 has a value of 2, a virtual frame rate is set to be equal to an original frame rate, for example, 30 Hz. If the index information has a value of 1, the virtual frame rate is set to half of the original frame rate, i.e., 15 Hz. If the index information has a value of 0, the virtual frame rate is set to a third of the original frame rate, i.e., 10 Hz.

In order to prevent motion jerkiness, it is preferable to reduce the frame rate of the predetermined section, for example, the frame rate of a corresponding GOP, when the motion activity of the predetermined section nearly reaches 0.

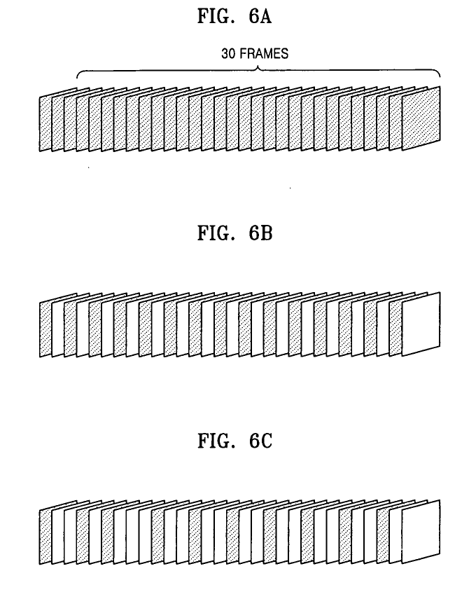

Once the virtual frame rate for the predetermined section is determined by the frame rate determination unit 340, the encoding unit 360 carries out sub-sampling of frames of the predetermined section according to the determined virtual frame rate, as shown in FIG. 6A through 6C, so as to virtually adjust the frame rate of the predetermined section. FIG. 6A illustrates sub-sampling of frames when the index information has a value of 2, FIG. 6B illustrates sub-sampling of frames when the index information has a value of 1, and FIG. 6C illustrates sub-sampling of frames when the index information has a value of 0. In FIGS. 6A through 6C, gray frames are to be encoded, and white frames are to be virtually skipped.

For example, in the case of MPEG-2 encoding frames starting with an ‘I’ frame followed by ‘P’ frames, all macroblocks of each slice of each white frame except for first and last macroblocks are encoded while treating them as skipped macroblocks. Since, according to the MPEG-2 standard, the first and last macroblocks of each slice cannot be skipped, the first and last macroblocks of each slice should not be set as skipped macroblocks. However, the first and last macroblocks of each slice can be treated as skipped macroblocks by setting them as ‘not coded’-type macroblocks which do not need to be encoded or ‘no motion compensation’ (‘no MC’)-type macroblocks. According to an exemplary embodiment of the present invention, skipped macroblocks are encoded using a macroblock address increment (MBAI) data field included in encoded data of a macroblock layer.

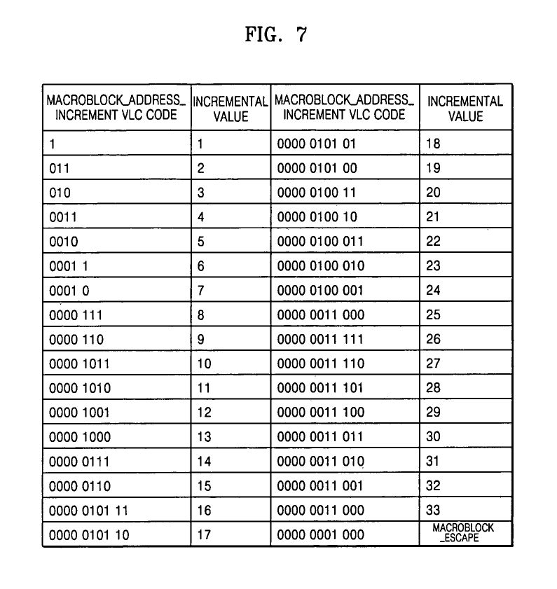

FIG. 7 is a table illustrating an example of variable length coding (VLC) used in a virtual frame skipping method according to an exemplary embodiment of the present invention. VLC codes shown in FIG. 7 are used for skipping macroblocks which do not have any data to be transmitted.

Each of the VLC codes shown in FIG. 7, i.e., macroblock_address_increment VLC codes, represents a difference between a current macroblock address current_macroblock_address and a previous macroblock address previous_macroblock_address as a VLC code.

Here, macroblocks which do not have any data to be transmitted are called skipped macroblocks, while macroblocks which have data to be transmitted are called non-skipped macroblocks. If a current macroblock is a non-skipped macroblock, its macroblock_address_increment is calculated using Equation (1) below.

macroblock_address_increment=previous_macroblock_address−current_macroblock_address (1)

In Equation (1), previous_macroblock_address indicates an address of a previous non-skipped macroblock.

A macroblock skipped due to MBAI is a ‘not coded’, ‘no MC’-type macroblock in a ‘P’ picture, which represents a simple motion estimation between frames, and is a ‘not coded’-type macroblock in a ‘B’ picture, which has the same estimated direction and motion vector as its previous macroblock.

In an MPEG-2 encoder according to the present invention, all macroblocks of each slice of a frame to be virtually skipped except for first and last macroblocks are forcefully treated as skipped macroblocks. The first and last macroblocks are set as ‘not coded’, ‘no MC’-type macroblocks so that they can be treated in the same manner as skipped macroblocks. More specifically, the first macroblock of each slice of the frame to be virtually skipped is set as a ‘not coded’-type macroblock and is encoded so that it can also be set as a ‘no MC’-type macroblock. In addition, the first macroblock of each slice of the frame to be virtually skipped has an MBAI value of 1, and its VLC code is shown in FIG. 7. The last macroblock of each slice of the frame to be virtually skipped is set as a ‘not coded’-type macroblock, and ‘no MC’-type information is encoded. Even if the MBAI value of the last macroblock of each slice of the frame to be virtually skipped is set to a result of adding 1 to the number of skipped macroblocks in each slice, the last macroblock of each slice of the frame to be virtually skipped is encoded in the manner illustrated in FIG. 7.

According to the embodiment of the present invention, the virtual frame skipping method according to the present invention is carried out on MPEG-encoded data. However, in some cases, the virtual frame skipping method according to the present invention may be applied to data encoded in a different method than MPEG-encoding.

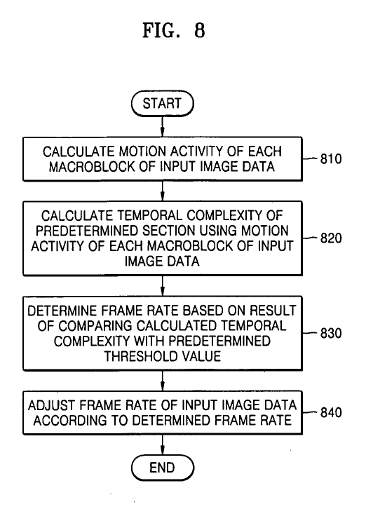

FIG. 8 is a flowchart of a method of adaptively encoding a motion image by using temporal complexity, according to an exemplary embodiment of the present invention.

In step 810, motion vector information of each macroblock of input image data is calculated, and motion activity of each macroblock of the input image data is calculated using the calculated motion vector information. According to the exemplary embodiment, in the case where a motion vector MV of a macroblock is represented by (MV1, MV2), motion activity of the motion vector MV is defined by MV1+MV2.

In step 820, temporal complexity of a predetermined section, i.e., a GOP, is calculated using the calculated motion activity. In the exemplary embodiment, a maximum among motion activities of macroblocks in the predetermined section is determined as the temporal complexity of the predetermined section. Alternatively, an average of the motion activities of the macroblocks in the predetermined section can be determined as the temporal complexity of the predetermined section.

In step 830, a frame rate is determined based on a result of comparing the temporal complexity of the predetermined section with a predetermined threshold value.

In step 840, frames of the input image data are virtually skipped based on the determined frame rate, as shown in FIGS. 6A through 6C.

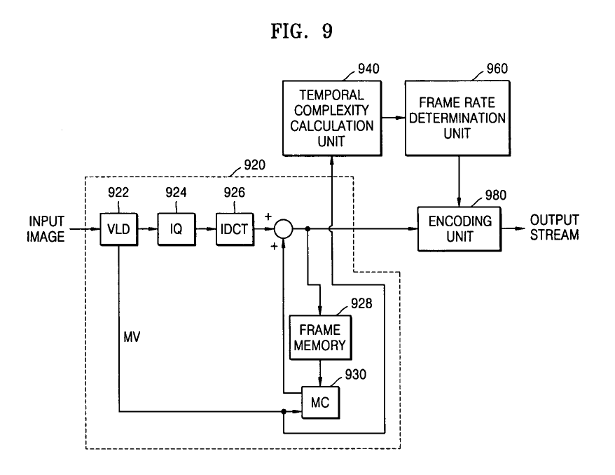

FIG. 9 is a block diagram of an apparatus for adaptively transcoding a motion image by using temporal complexity, according to an exemplary embodiment of the present invention. Referring to FIG. 9, the apparatus includes a motion image decoding unit 920, a temporal complexity calculation unit 940, and a frame rate determination unit 960, and an encoding unit 980. The motion image decoding unit 920 includes a VLC decoding unit 922, an inverse quantization unit 924, an inverse DCT unit 926, a frame memory unit 928, and a motion compensation unit 930.

If input image data is a compressed stream, the temporal complexity calculation unit 940 calculates temporal complexity of the input image data on the basis of a predetermined unit, for example, on a GOP-by-GOP basis, by using motion vector information obtained by decoding the compressed stream.

As shown in FIG. 9, the temporal complexity calculation unit 940 receives a motion vector MV from the VLC decoding unit 922, calculates motion activity of each macroblock using the motion vector MV, and calculates temporal complexity of a predetermined section using the calculated motion activity. The frame rate determination unit 960 and the encoding unit 980 perform the same functions as their respective counterparts of FIG. 3, and thus their description will not be repeated here.

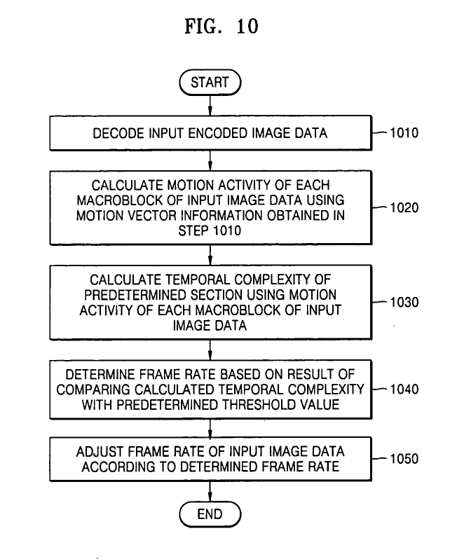

FIG. 10 is a flowchart of a method of adaptively transcoding a motion image by using temporal complexity, according to an exemplary embodiment of the present invention.

In step 1010, input encoded image data is decoded.

In step 1020, motion vector information of each macroblock of the input image data is calculated using motion vector information obtained in step 1010, and motion activity of each macroblock of the input image data is calculated using the calculated motion vector information.

In step 1030, temporal complexity of a predetermined section is calculated using the motion activity calculated in step 1020. In the exemplary embodiment, a maximum among motion activities of macroblocks in the predetermined section is determined as the temporal complexity of the predetermined section. Alternatively, an average of the motion activities of the macroblocks in the predetermined section can be determined as the temporal complexity of the predetermined section

In step 1040, a frame rate is determined based on a result of comparing the temporal complexity of the predetermined section calculated in step 1030 with a predetermined threshold value.

In step 1050, frames of the input image data are virtually skipped, as shown in FIGS. 6A through 6C.

In an MPEG-2 stream, a GOP header comes right after a sequence header. The sequence header is placed at the beginning of an entire sequence, and the GOP header is placed wherever a GOP begins. Image size information only exists in the sequence header. However, in the case of transmitting an MPEG-2 stream for a broadcast, a sequence header is transmitted on a GOP-by-GOP basis. Therefore, if an MPEG-2 stream is created by inserting a sequence header into each GOP in an encoding process, it is possible to easily decode the MPEG-2 stream without any problems.

The present invention can be realized as computer-readable codes written on a computer-readable recording medium. The computer-readable recording medium includes any kind of recording device on which data can be written in a computer-readable manner. For example, the computer-readable recording medium includes ROM, RAM, CD-ROM, a magnetic tape, a hard disk, a floppy disk, flash memory, an optical data storage, and a carrier wave (such as data transmission through the Internet). In addition, the computer-readable recording medium can be distributed over a plurality of computer systems which are connected to one another in a network sort of way so that computer-readable codes are stored on the computer-readable recording medium in a decentralized manner.

As described above, according to the present invention, it is possible to simplify encoding and decoding processes, enhance data compression rate, and more efficiently store motion images on a storage medium by calculating temporal complexity of an image on the basis of a predetermined unit, encoding a section having low temporal complexity with a frame rate lower than an original frame rate and encoding a section having high temporal complexity with the original frame rate.

What is claimed is:

1. A method of adaptively encoding a motion image, the method comprising:
(a) calculating temporal complexity of a predetermined section of input image data;
(b) determining a virtual frame rate for the predetermined section based on a result of comparing the temporal complexity with a predetermined threshold value; and
(c) virtually adjusting a frame rate of the predetermined section based on the virtual frame rate.

2. The method of claim 1, wherein step (c) comprises (c1) setting macroblocks of the predetermined frame as ‘not coded’-type macroblocks according to the virtual frame rate.

3. The method of claim 2, wherein in step (c1), a macroblock address increment (MBAI) data field of MPEG-encoded data is used to virtually adjust the frame rate.

4. The method of claim 1, wherein the temporal complexity of the predetermined section is calculated using motion activity of each macroblock of the predetermined section.

5. The method of claim 4, wherein the motion activity of each macroblock of the input image data is calculated using a motion vector of each macroblock of the predetermined section.

6. The method of claim 5, wherein (MV 1, MV2) represents the motion vector of each macroblock of the input image data, and the motion activity of each macroblock of the input image data is represented by MV1¹+MV2².

7. The method of claim 1, wherein the predetermined section is a group-of-pictures (GOP) of the input image data.

8. The method of claim 1, wherein the predetermined section is a sequence of the input image data.

9. The method of claim 1 further comprising:
(a1) decoding the image data if the input image data is compressed,
wherein the temporal complexity of the predetermined section is calculated using a motion vector obtained in step (al).

10. The method of claim 1, wherein the temporal complexity of the predetermined section is calculated as a maximum among motion activity values of macroblocks in the predetermined section.

11. The method of claim 1, wherein the temporal complexity of the predetermined section is calculated as an average of motion activity values of macroblocks in the predetermined section.

12. An apparatus for adaptively encoding a motion image, the apparatus comprising:
a temporal complexity calculation unit which calculates temporal complexity of a predetermined section of input image data;
a frame rate determination unit which determines a virtual frame rate for the predetermined section based on a result of comparing the temporal complexity with a predetermined threshold value; and
a frame rate adjustment unit which virtually adjusts a frame rate of the predetermined section based on the virtual frame rate.

13. The apparatus of claim 12, wherein the frame rate adjustment unit sets macroblocks of the predetermined frame as ‘not coded’-type macroblocks according to the virtual frame rate.

14. The apparatus of claim 13, wherein the frame rate adjustment unit carries out frame rate adjustment using a macroblock address increment (MBAI) data field of MPEG-encoded data.

15. The apparatus of claim 12, wherein the temporal complexity of the predetermined section is calculated using motion activity of each macroblock of the predetermined section.

16. The apparatus of claim 15, wherein the motion activity of each macroblock of the input image data is calculated using a motion vector of each macroblock of the predetermined section.

17. The apparatus of claim 16, wherein (MV1, MV2) represents the motion vector of each macroblock of the input image data, and the motion activity of each macroblock of the input image data is represented by MV1²+MV2².

18. The apparatus of claim 12, wherein the predetermined section is a group-of-pictures (GOP) of the input image data.

19. The apparatus of claim 12, wherein the predetermined section is a sequence of the input image data.

20. The apparatus of claim 12 further comprising:
a decoding unit which decodes the image data if the input image data is compressed,
wherein the temporal complexity calculation unit calculates the temporal complexity of the predetermined section using a motion vector provided by the decoding unit.

21. The apparatus of claim 12, wherein the temporal complexity calculation unit determines a maximum among motion activity values of macroblocks in the predetermined section as the temporal complexity of the predetermined section.

22. The apparatus of claim 12, wherein the temporal complexity calculation unit determines an average of motion activity values of macroblocks in the predetermined section as the temporal complexity of the predetermined section.

23. A method of adaptively encoding a motion image, the method comprising:
(a) calculating temporal complexity of a predetermined section of input image data;
(b) comparing the temporal complexity of the predetermined section with a predetermined threshold value; and
(c) adjusting a frame rate of the predetermined section based on a result of comparing the temporal complexity of the predetermined section with the predetermined threshold value.

24. The method of claim 23, wherein step (b) comprises determining a virtual frame rate of the predetermined section based on the result of the comparison of the temporal complexity of the predetermined section with the predetermined threshold value, and
wherein step (c) comprises sub-sampling frames of the predetermined section according to the virtual frame rate so as to virtually adjust the frame rate of the predetermined section.

25. The method of claim 23, wherein the temporal complexity of the predetermined section is calculated as a maximum among motion activity values of macroblocks in the predetermined section.

26. The method of claim 23, wherein the temporal complexity of the predetermined section is calculated as an average of motion activity values of macroblocks in the predetermined section.
